(19) United States
(12) Patent Application Publication
(10) Pub. No.: US 2016/0283972 A1
(43) Pub. Date: Sep. 29, 2016

(54) DETECTION OF FAILURE TO DISPLAY ADVERTISEMENTS

(71) Applicant: Google Inc., (US)

(72) Inventor: Jordan John BAYLISS-MCCULLOCH, Beaconsfield (AU)

(73) Assignee: Google Inc., Mountain View, CA (US)

(21) Appl. No.: 13/865,084

(22) Filed: Apr. 17, 2013

(51) Int. Cl. G06Q 30/00

(52) U.S. Cl. CPC G06Q 30/0246; G06Q 30/0273

(57) ABSTRACT

A system and machine-implemented method for detecting an error in displaying advertisement content, the method including receiving one or more ads for display at a user device in response to a request from the user device, determining information regarding the one or more ads, determining if the one or more ads are displayed correctly based on the information regarding the one or more ads, identifying one or more incorrect ads of the one or more ads if it is determined that the one or more ads are not displayed correctly based on the information regarding the one or more ads and determining an updated price to charge one or more advertisers associated with the identified one or more incorrect ads based at least in part on the fact that the identified one or more incorrect ads have been displayed incorrectly.

### BACKGROUND

When ads are sent from a server to a client for display to a user, it is the objective that the ad will be displayed to and seen by the user. Whether an ad is displayed to a user has implications for advertisers as well as for the determination of ad quality. For example, advertisers may pay for an advertisement on a cost-per-impression basis, in which case, impressions for ads not seen by the user cost money while they are not in fact displayed to the user. Ad systems use complex machine-learning systems to predict success rate for ads (e.g., CTR (click-through-rate)), which in part determines the price (e.g., CPC, cost-per-click) for an ad. Ads that are not shown cannot be clicked, leading to over-counting of impressions and an inaccurate predicted CTR, which is trained based on clicks-per-impression. Thus, it would be useful to provide a more accurate record of ad impressions to address these issues.

### SUMMARY

The disclosed subject matter relates to a machine-implemented method for detecting an error in displaying advertisement content, the method comprising receiving, using one or more computing devices, one or more ads for display at a user device in response to a request from the user device. The method further comprising determining, using the one or more computing devices, information regarding the one or more ads. The method further comprising determining, using the one or more computing devices, if the one or more ads are displayed correctly based on the information regarding the one or more ads. The method further comprising identifying, using the one or more computing devices, one or more incorrect ads of the one or more ads if it is determined that the one or more ads are not displayed correctly based on the information regarding the one or more ads and determining, using the one or more computing devices, an updated price to charge one or more advertisers associated with the identified one or more incorrect ads based at least in part on the fact that the identified one or more incorrect ads have been displayed incorrectly.

The disclosed subject matter also relates to a system for detecting an error in displaying advertisement content, the system comprising one or more processors and a machine-readable medium comprising instructions stored therein, which when executed by the processors, cause the processors to perform operations comprising receiving content including one or more ads for display at a user device. The operations further comprising receiving information regarding the one or more ads at the user device, the information including one or more of a total number of ads, an identifier of each of the one or more ads and a location associated with each of the one or more ads. The operations further comprising generating a user interface for display based on the received content. The operations further comprising determining if at least one of the one or more ads is not displayed correctly within the user interface based on the information regarding the one or more ads. The operations further comprising identifying an incorrect ad of the one or more ads not being displayed correctly within the user interface if at least one of the one or more ads is not displayed correctly within the user interface and updating advertiser information regarding the incorrect ad, wherein the advertiser information regarding the at least one of the one or more ads includes one or more of a price charged for the incorrect ad or metrics regarding the incorrect ad.

The disclosed subject matter also relates to a machine-readable medium comprising instructions stored therein, which when executed by a machine, cause the machine to perform operations comprising receiving one or more ads for display at a user device in response to a request from a user at the user device. The operations further comprising determining information regarding the one or more ads. The operations further comprising determining if the one or more ads are displayed correctly based on the information regarding the one or more ads. The operations further comprising identifying an incorrect ad of the one or more ads if it is determined that the one or more ads are not displayed correctly based on the information regarding the one or more ads and updating advertiser information regarding the incorrect ad based at least in part on the fact that the identified incorrect ad has been displayed incorrectly.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment which provides for detecting failure to correctly display ads.

FIG. 2 illustrates a flow diagram of an example process for detecting failure to correctly display ads.

FIG. 3 illustrates an example user interface providing content for display to a user including one or more ads.

FIG. 4 illustrates an example user interface providing content for display to a user where the one or more ads are not displayed within the user interface.

FIG. 5 illustrates an example user interface displaying information in response to a user interaction with an ad or entity including intended content regarding an ad.

FIG. 6 illustrates an example user interface where the content provided for display in response to user interaction does not include ad information intended for display.

FIG. 7 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

The present disclosure provides a method and system for detecting whether ads provided for display to a user are fully displayed to the user, and taking actions in view of the detection. Information regarding the failure to display an ad correctly may be used to ensure that an advertiser is not charged for undisplayed or partially displayed ads. Additionally, the metrics and/or analytics information regarding an ad or ad campaign (e.g., number of impressions, CTR, etc.) may be adjusted according to the detected failure to display an ad correctly. In another example, the detection may be an indication of an error (e.g., system and/or rendering failure).

There may be various reasons that an ad provided for display to a user is not displayed and/or partially displayed to the user. Both the failure to display an ad or partial display of the ad may be detected as a failure to display an ad correctly. Partial display of an ad may occur, for example, when the ad graphics are rendered and provide for display, but the displayed ad graphics are not clickable or do not cause intended content to be displayed.

An ad may fail to be displayed either due to an error or due to an ad blocker being installed at the client device. There are two different instances where the system may check to see if an ad has failed to be displayed. The first instance occurs when the ads are first rendered and provided for display. At this point, a check may be performed to determine if the content displayed to the user includes the correct number of ads, the ads displayed are the correct ads and/or are displayed correctly. When ads are provided for display to the user at the client, the client may receive information about the number of ads provided for display, as well as information regarding each ad (e.g., from the server in response to a request for ads). The ad information may include an identifier for the ad, a location where the ad should be displayed within the user interface and/or the content items that should be displayed when the ad is clicked.

The client provides the ads and other content (e.g., map data, points of interest, etc.) for display to the user. For example, data received from data providers (e.g., one or more servers providing map content and/or other organic content and ads) is sent to a rendering engine and rendered for display to the user. Once the content is rendered for display (e.g., organic content and ads), the ad information including the number of ads, the identifiers for the ads, and the location information for each ad is used to determine if the right number of ads are displayed, if the displayed ads are the correct ads, and if the displayed ads are displayed at or near their intended location. Other information may also be provided by the server, and checked when determining if ads are displayed (e.g., font, size, etc.).

If it is determined that one or more intended ads are not displayed and/or not displayed in the intended manner (e.g., location), the ads not correctly displayed are identified (e.g., based on the identifiers for each ad). The failure to display ads correctly may be due to ad blockers or other factors (e.g., ads not being correctly rendered due to compromised ad data or rendering process). The detected failure to display one or more intended ads may be reported to the server for various reasons. For example, information regarding the failure to display an ad correctly may be used to ensure that an advertiser is not charged for undisplayed or partially displayed ads. Additionally, the metrics regarding the ad or ad campaign (e.g., number of impressions, CTR, etc.) may be adjusted according to the detected failure to display the ad correctly.

The next instance where ad display is checked is when the user interacts with a displayed ad. In one example, an ad may be displayed, but the ad might not be active or might not cause intended content to be displayed to the user once the user chooses to interact with the ad. It is important to make sure that once ads are displayed, the desired information is provided as a result of user interaction with the ad, increasing the likelihood of the ad leading to desired conversion activity. Thus, even where an ad is displayed in a desired manner, if the ad is not active and/or does not lead to the desired content being displayed, the ad may not have any value for the advertiser, and the analytics information regarding the ad (e.g., CTR, conversion rate, etc.) may not be accurate since the right information was not provided for display to a user interacting with the ad.

Accordingly, in some implementations, upon receiving an indication of a user interaction with an ad being displayed, the system determines the content that should be displayed to the user in response to the interaction. In some examples, ad information includes information regarding content items that should be displayed upon user interaction with an ad. The information regarding the content items may include identifying information for the content items and the manner in which the content items should be displayed (e.g., location, font, size, etc.). The system then compares the information regarding intended content and/or manner of displaying the intended content to what is actually displayed in response to the user interaction. If it is determined that the content is not displayed as intended (e.g., the content items are not displayed or not displayed as intended), an error is detected. The error may be reported (e.g., to the server or content or ad provider) to ensure that an advertiser is not charged for partially displayed ads. Additionally, the analytics and metrics regarding the ad or ad campaign (e.g., number of impressions, CTR, etc.) may be adjusted according to the detected partial display of the ad.

In this manner, advertisers are charged more accurately according to what ads are actually displayed to a user and provide the right content to the user that is likely to lead to desired conversion activities. Furthermore, metrics and analytics regarding ads are made more accurate by taking into account if ads are displayed as intended.

II. Example Client-Server Network Environments for Detection of Failure to Display Advertisements

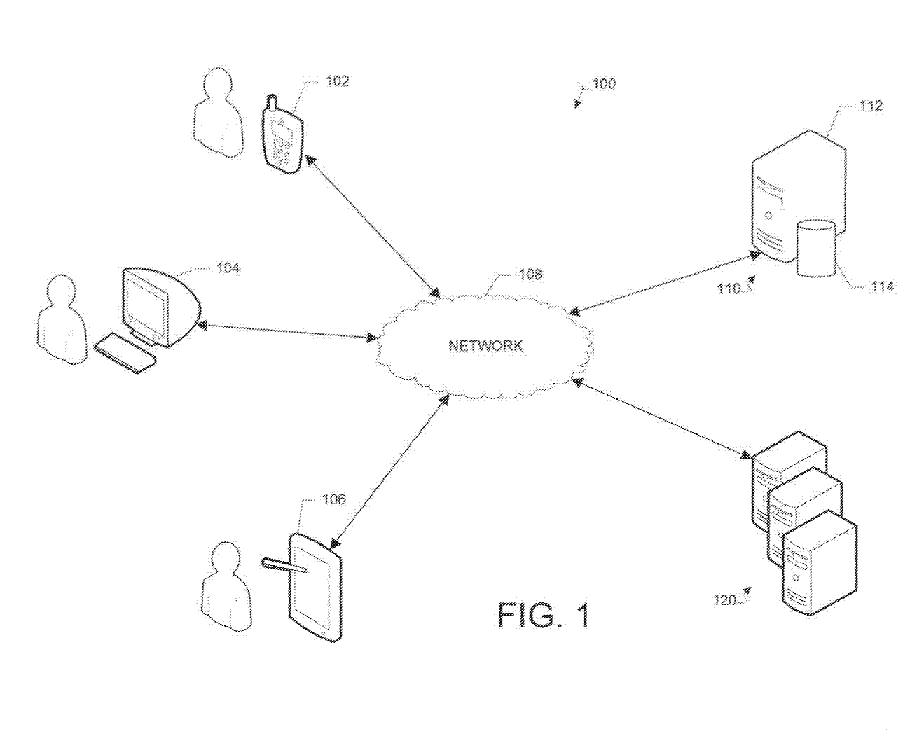

FIG. 1 illustrates an example client-server network environment which provides for detecting failure to correctly display ads. A network environment 100 includes a number of electronic devices 102, 104 and 106 communicably connected to a server 110 by a network 108. One or more remote servers 120 are further coupled to the server 110 and/or the one or more electronic devices 102, 104 and 106.

In some example embodiments, electronic devices 102, 104 and 106 can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application. In one example, the electronic devices 102, 104 and 106 store a User agent such as a browser or application. In the example of FIG. 1, electronic device 102 is depicted as a smartphone, electronic device 104 is depicted as a desktop computer, and electronic device 106 is depicted as a PDA.

Server 110 includes a processing device 112 and a data store 114. Processing device 112 executes computer instructions stored in data store 114, for example, to assist in detecting failure to correctly display ads at electronic devices 102, 104 and 106.

In some example aspects, server 110 can be a single computing device such as a computer server. In other embodiments, server 110 can represent more than one computing device working together to perform the actions of a server computer (e.g., cloud computing). The server 110 may host the web server communicationally coupled to the browser at the client device (e.g., electronic devices 102, 104 or 106) via network 108. In one example, the server 110 may host a system for detecting failure to correctly display ads. Server 110 may further be in communication with remote servers 120 either through the network 108 or through another network or communication means.

In one example, the system may further comprise one or more other remote servers 120 performing various functionalities and/or storage capabilities. Each of the one or more remote servers 120 can be a single computing device such as a computer server or can represent more than one computing device working together to perform the actions of a server computer (e.g., cloud computing). Each of the one or more remote servers 120 may host one or more of search engines, data repositories, advertisement services, websites or webpages associated with an advertisers, analytics services, or other data stores, services or applications. In one embodiment server 110 and one or more remote servers 120 may be implemented as a single server. In one example, the server 110 and one or more remote servers 120 may communicate through the user agent at the client device (e.g., electronic devices 102, 104 or 106) via network 108.

Communications between the client devices 102, 104, 106, server 110 and/or one or more remote servers 120 may be facilitated through the HTTP communication protocol. Other communication protocols may also be facilitated including for example, XMPP communication, for some or all communications between the client devices 102, 104, 106, server 110 and one or more remote servers 120 (e.g., through network 108).

Users may interact with the system hosted by server 110, and/or one or more services hosted by remote servers 120, through a client application installed at the electronic devices 102, 104, 106. Alternatively, the user may interact with the system and the one or more services through a web based browser application at the electronic devices 102, 104, 106. Communication between client devices 102, 104, 106 and the system, and/or one or more services, may be facilitated through a network (e.g., network 108).

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

III. Example Processes for Detection of Failure to Display Advertisements

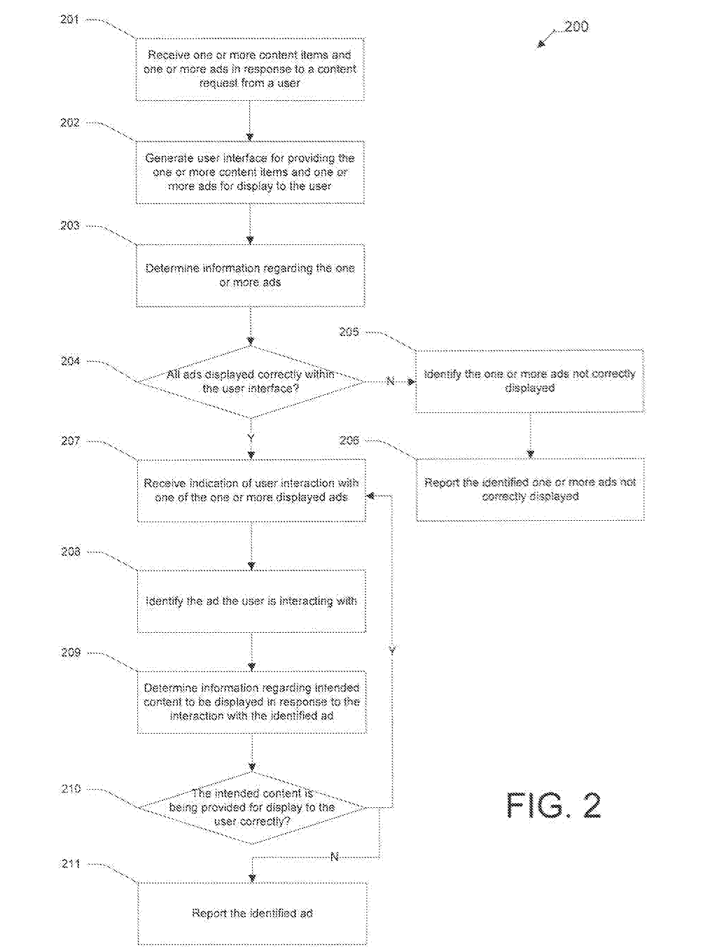

FIG. 2 illustrates a flow diagram of an example process 200 for detecting failure to correctly display ads. In block 201, one or more content items and one or more ads are received in response to a content request from a user. In one example, for one or more received ads, information about the number of ads, as well as information regarding each ad is received (e.g., received at the client device from one or more servers in response to a request for the content or for ads). The ad information may include an identifier for the ad, a location where the ad should be displayed within the user interface and/or the content items that should be displayed when the ad is clicked.

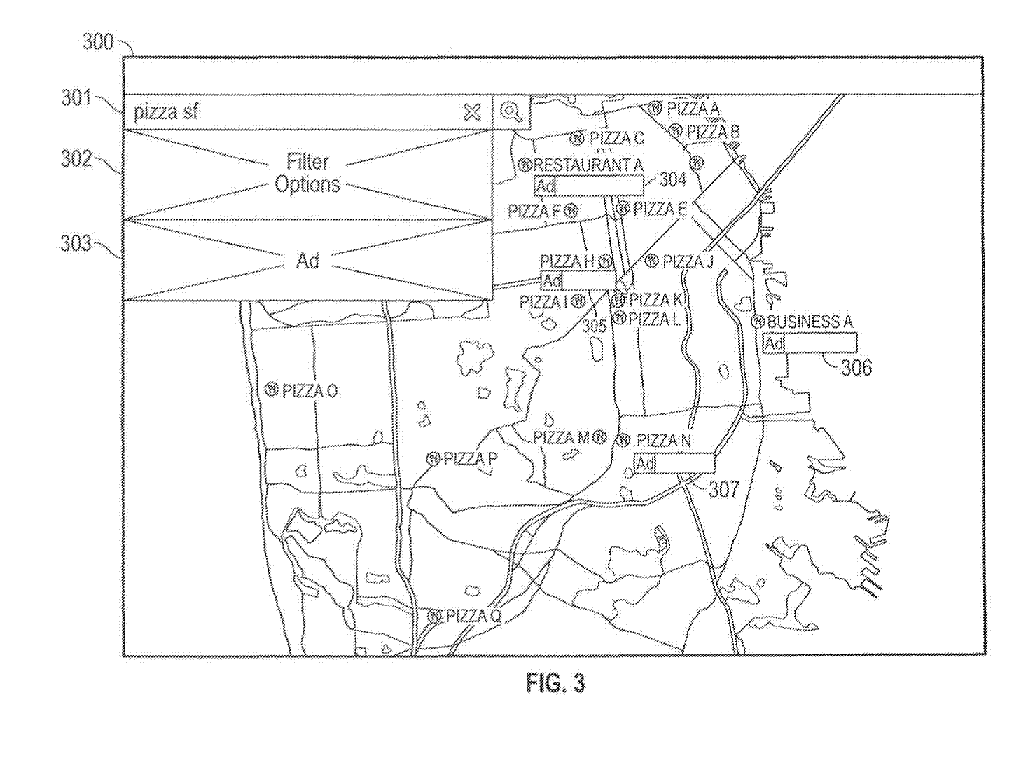

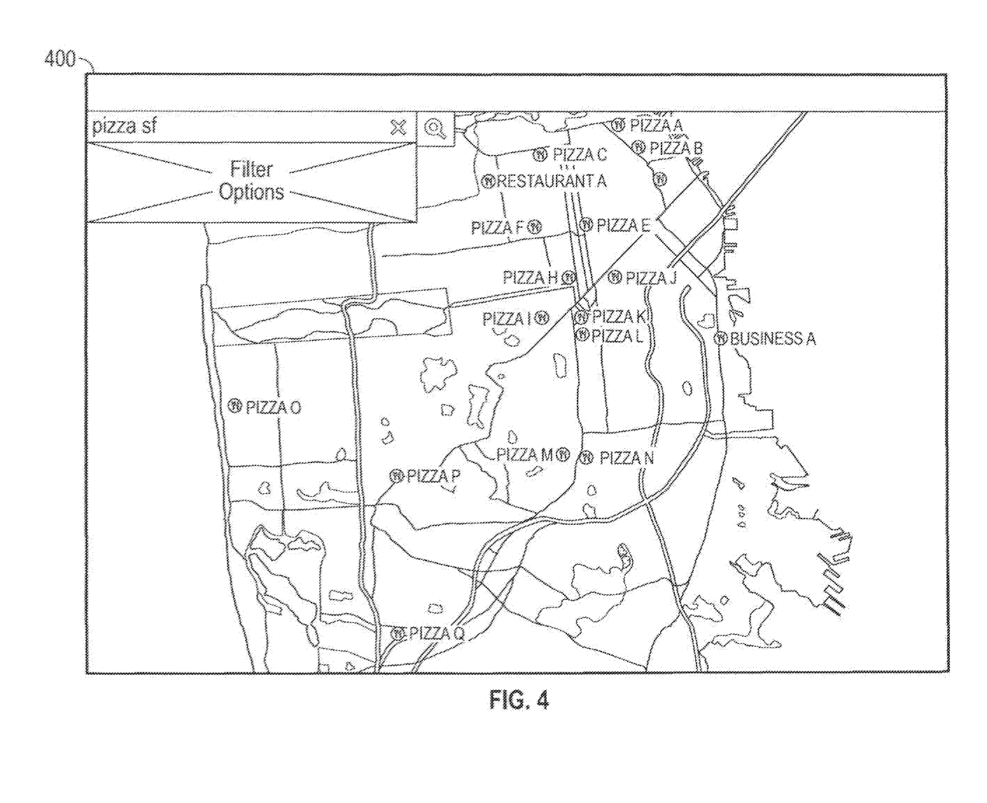

In block 202, a user interface is generated for display to a user in response to the user request for content. The one or more content items and one or more ads may be provided for rendering to generate the user interface. For example, data received from one or more data providers (e.g., one or more servers providing map content and/or other organic content and ads) is sent to a rendering engine and rendered for display. In one example, the one or more ads may be blocked by an ad blocker such that they are either not sent to the render engine and/or not rendered at the render engine. In another example, other errors may cause the render engine to not receive all of the intended ads and/or to not correctly render the intended ads. FIG. 3, described in more detail below, illustrates an example user interface 300 providing content for display to a user including one or more ads. FIG. 4, described in more detail below, illustrates an example user interface 400 providing content for display to a user where the one or more ads are not displayed within the user interface.

In block 203, information regarding the one or more ads is determined. As described above, information regarding one or more ads may be received from one or more data providers. In block 204, The ad information including, for example, the number of ads, the identifiers for the ads, and the location information for each ad is used to determine if the ads are displayed correctly. For example, the information regarding the number of ads is compared to the number of ads being provided for display to determine if the right number of ads is displayed. Furthermore, identifiers and location information for the one or more received ads is compared to the ads provided for display to determine if the displayed ads are the correct ads, and if the displayed ads are displayed at or near their intended location. Other information may also be provided by the server, and checked when determining if ads are displayed correctly (e.g., font, size, etc.).

If, in block 204, it is determined that one or more intended ads are not displayed and/or not displayed in the intended manner (e.g., location), in block 205, the one or more ads not correctly displayed are identified (e.g., based on the identifiers for each ad). The failure to display ads correctly may be due to ad blockers or other factors (e.g., ads not being correctly rendered due to compromised ad data or rendering process).

In block 206, the detected failure to display one or more intended ads may be reported. In one example, the reporting may include the specific identifier for the ads that were not correctly displayed. In some examples, overall error information regarding the failure to display one or more ads may be provided. The information regarding the failure to display an ad correctly may be used to adjust the price an advertiser is charged for the undisplayed or partially displayed ads. Additionally, the metrics regarding the ad or ad campaign (e.g., number of impressions, CTR, etc.) may be adjusted according to the detected failure to display the ad correctly.

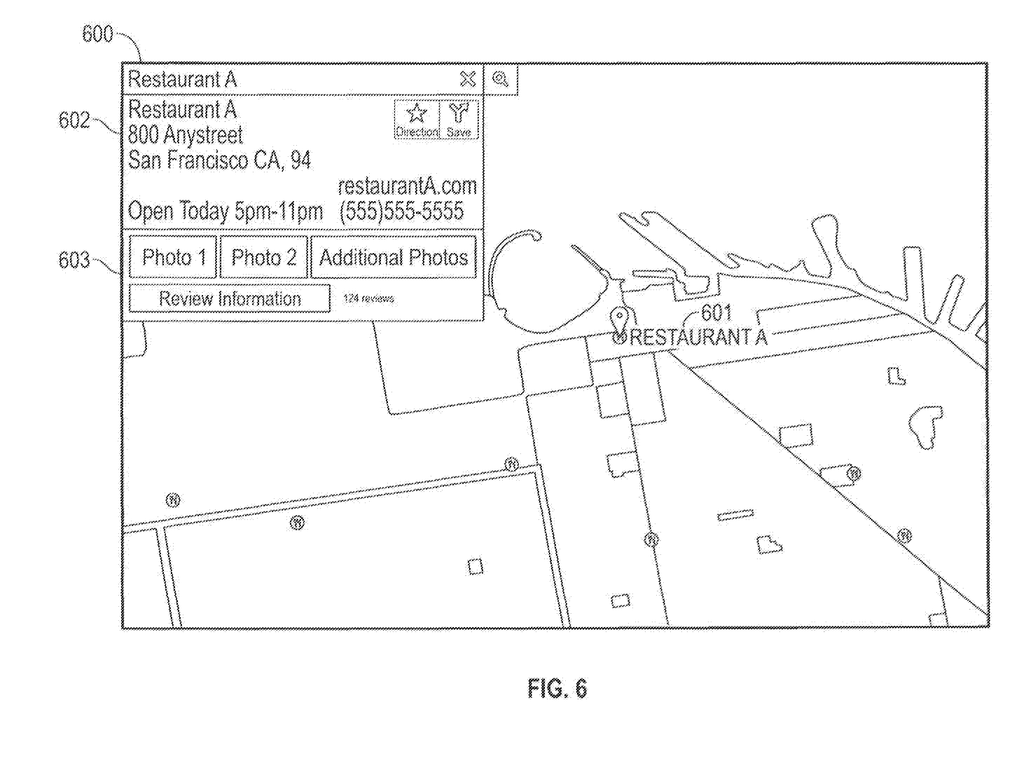

In one example, while the one or more ads may be correctly rendered according to the determination in block 204 (e.g., the correct number of ads, the correct ads and in the intended manner), one or more ads may not be active or may not cause intended content to be displayed to the user once the user chooses to interact with the ad. It is important to make sure that once ads are displayed, the desired information is provided as a result of user interaction with the ad, increasing the likelihood of the ad leading to desired conversion activity. For example, an ad may be a link to a full ad card, where interaction with the ad causes ad data, including, for example, an ad card including an ad and landing page, to be displayed. Thus, even where an ad is displayed in a desired manner, if the ad does not lead to the desired content being displayed, the ad may not have any value for the advertiser, and the analytics information regarding the ad (e.g., CTR, conversion rate, etc.) may not be accurate since the right information was not provided for display to a user interacting with the ad. FIG. 6, described in more detail below, illustrates an example ad where interaction with the ad may not result in intended content being displayed to the user.

In block 207, an indication of a user interaction with an ad being displayed is received. In one example, the interaction may include a mouse-click, mouse-hover, or otherwise selection or highlighting of an icon representing the ad and/or associated entity by the user, for example, using a user input device. In block 208, the ad that the user is interacting with is identified (e.g., according to the identifier associated with the displayed ad).

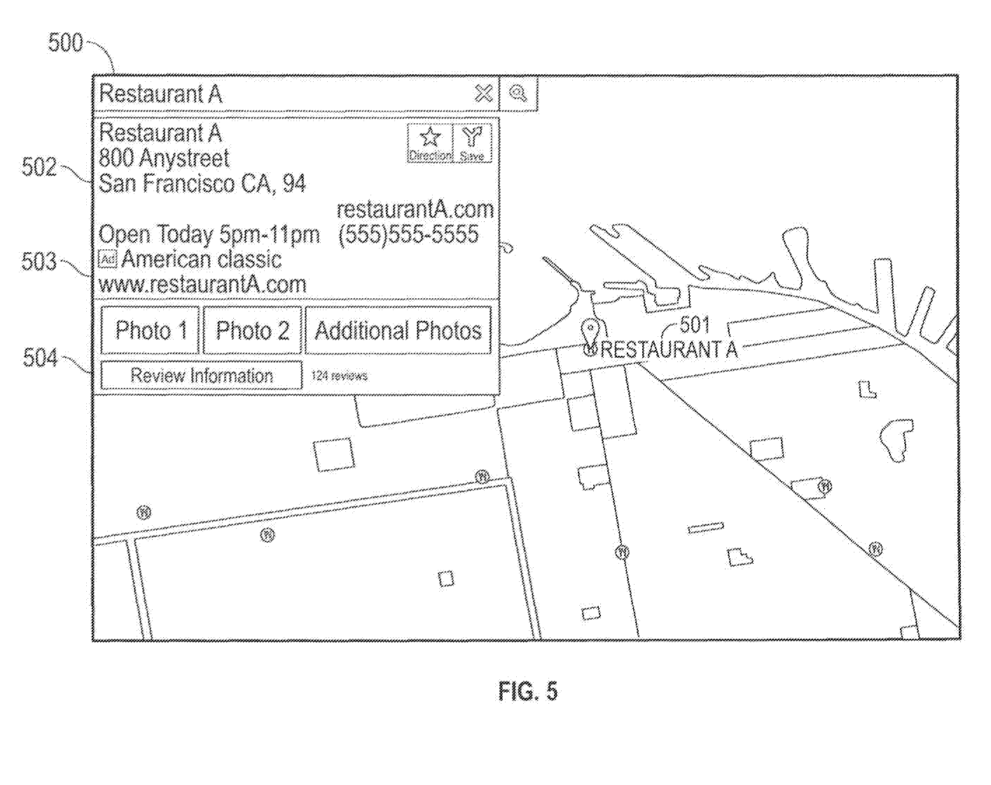

In block 209, information regarding the intended content to be provided for display in response to the user interaction is determined. As described above, when ads are received to be provided for display to a user in response to a user request for content, ad information including information regarding content items that should be displayed upon user interaction with an ad is provided. The information may include one or more content items and the manner in which the content items should be displayed (e.g., location, font, size, etc.). FIG. 5, described in more detail below, illustrates an example user interface 500 displaying information in response to a user interaction including intended content regarding an ad. FIG. 6, described in more detail below, illustrates an example user interface 600 where the content provided for display in response to user interaction does not include content items intended for display.

In block 210, the system determines if the intended content is being provided to the user correctly. In one example, information regarding intended content and/or manner of displaying the intended content is compared to content actually provided for display in response to the user interaction. If, in block 210, it is determined that the intended content is not provided for display correctly, in block 211, the error to display the ad and/or intended content associated with the ad is reported. In one example, the error may be reported (e.g., to the server or content or ad provider) to ensure that an advertiser is not charged for partially displayed ads. Additionally, the analytics and metrics regarding the ad or ad campaign (e.g., number of impressions, CTR, etc.) is adjusted according to the detected partial display of the ad.

Otherwise, if, in block 210, it is determined that the content displayed is as intended, the content is provided for display to the user and no further action may be taken until the user interacts with another ad which causes blocks 207-211 to be repeated with respect to that ad. If it is determined that the content is not displayed as intended, an error is detected.

In this manner, advertisers are charged more accurately according to what ads are actually displayed to a user, and provide the right content to the user that is likely to lead to desired conversion activities. Furthermore, metrics and analytics regarding ads are made more accurate by taking into account if ads are displayed as intended.

IV. Example User Interfaces for Displaying Content Including Advertisements

FIG. 3 illustrates an example user interface 300 providing content for display to a user including one or more ads. User interface 300 illustrates a map including organic content. The map may include various map content provided to a user, for example in response to a user search request. For example, as displayed, a search box 301 is provided for entering search criteria for retrieving organic map content to be displayed within the map. For example, a search query “pizza sf” is displayed as being entered in search box 301. A filter box 302 is further displayed. In one example, the filter box 302 may provide the user with additional search suggestions, filter criteria and a link to an alternative view of the results (e.g., a list view). An ad box 303 may further display an ad matching the search criteria provided within search box 301. The ad displayed within filter box 303 may be one of the ads displayed within the map or may be a different ad.

In response to the search query, one or more organic map content (e.g., businesses) matching the criteria is retrieved and provided for display within the map. For example, as displayed one or more pizza restaurants are displayed within the map. One or more other related entities or entities within the vicinity may also be displayed within the map. In one example, ads associated with one or more entities displayed within the map may be received and displayed within the map. In one example, the ads may be clustered with the entity associated with the ad and displayed within the map.

For example, as displayed in user interface 300, ads 304, 305 and 306 are displayed. Ad 304 is associated with restaurant A, ad 305 is associated with Pizza H, ad 306 is associated with business A and ad 307 is associated with Pizza N. In one example, each entity and/or ad displayed within the map is selectable by the user. When the user interacts with an entity (e.g., using a user input device) content items associated with the entity are provided for display to the user.

FIG. 4 illustrates an example user interface 400 providing content for display to a user where the one or more ads are not displayed within the user interface. A map similar to the map of user interface 300 is displayed in the user interface 400. However, no ads are provided for display in user interface 400. The failure to display ads may be due to ad blockers at the client device or render engine and/or a failure that caused the ads to not be rendered and/or provide for display within the graphical user interface 400. In one example, when such failure to display ads is detected, the failure may be reported, such that information about ads intended to be displayed with the user interface (e.g., ads 304, 305 and 306 of FIG. 3) are adjusted according to the ads not being provided for display to the user in the user interface 400.

FIG. 5 illustrates an example user interface 500 displaying information in response to a user interaction with an ad or entity including intended content regarding an ad. A user may click on an entity or an ad clustered with an entity being displayed on the map. A user may interact with a first item 501 (labeled “restaurant A”) displayed on the map. In response to the interaction, content items relating to item 501 may be displayed to the user. For example, an entity card 502 may be displayed including information regarding the entity including for example the address, website, phone number and hours of the business. Furthermore, links to various services such as direction services or links to social networking services may be displayed on the entity card 502. In one example, where the entity is associated with an ad, as displayed in user interface 500, the entity card may further include an ad 503. The ad may include a landing page and ad content. Other information including photos, reviews, and links to various other services may be displayed for example in an auxiliary information area 504.

FIG. 6 illustrates an example user interface 600 where the content provided for display in response to user interaction does not include ad information intended for display. Similar to user interface 500, user interface 600 displays items associated with a first item 601 (labeled “restaurant A”). Item 601 is the same entity as item 501 of user interface 500. In response to the interaction, content items relating to item 601 may be displayed to the user. Similar to user interface 500, user interface 600 provides an entity card 602, including entity information and auxiliary information 603, for display to the user. However, unlike the entity card 502 displayed in user interface 500, the entity card 602 does not include ad content similar to ad 503. This absence of ad information in the entity card may alert the system that a failure to display ad information occurred and may cause a reporting of the error and/or adjusting ad information relating to the ad (e.g., ad 503) according to the ad information not being displayed within entity card 602 of user interface 600.

V. Example Systems for Detection of Failure to Display Advertisements

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

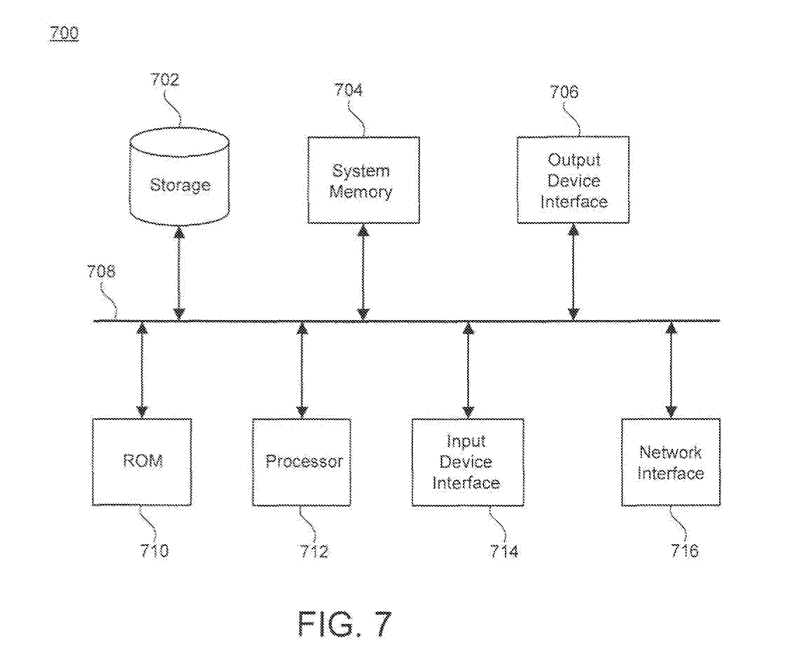

FIG. 7 conceptually illustrates an electronic system with which some implementations of the subject technology are implemented. Electronic system 700 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 700 includes a bus 708, processing unit(s) 712, a system memory 704, a read-only memory (ROM) 710, a permanent storage device 702, an input device interface 714, an output device interface 706, and a network interface 716.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, and/or ROM 710. For example, the various memory units include instructions for detecting failure to correctly display ads according to various embodiments. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, for example, alphanumeric keyboards and pointing devices (also called “cursor control devices”). Output device interfaces 706 enables, for example, the display of images generated by the electronic system 700. Output devices used with output device interface 706 include, for example, printers and display devices, such as cathode ray tubes (CRT) or liquid crystal displays (LCD). Some implementations include devices such as a touchscreen that functions as both input and output devices.

Finally, as shown in FIG. 7, bus 708 also couples electronic system 700 to a network (not shown) through a network interface 716. In this manner, the computer can be a part of a network of computers (such as a local area network (“LAN”), a wide area network (“WAN”), or an Intranet, or a network of networks, such as the Internet. Any or all components of electronic system 700 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure. Features under one heading may be combined with features under one or more other heading and all features under one heading need not be use together. Features under one heading may be combined with features under one or more other heading and all features under one heading need not be use together.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for detecting an error in displaying advertisement content, the method comprising:
receiving, using one or more computing devices, one or more ads for display at a user device in response to a request from the user device;
determining, using the one or more computing devices, information regarding the one or more ads;
determining, using the one or more computing devices, that at least one of the one or more ads are not displayed correctly based on the information regarding the one or more ads, the at least one of the one or more ads that are not displayed correctly comprising one or more incorrect ads, wherein the one or more incorrect ads are not displayed correctly due to an ad blocker application present as part of a web browser of the user device;
identifying, using the one or more computing devices, the one or more incorrect ads; and
determining, using the one or more computing devices, an updated price to charge one or more advertisers associated with the identified one or more incorrect ads based at least in part on the fact that the identified one or more incorrect ads have been displayed incorrectly.

2. The method of claim 1, further comprising:
reporting, using the one or more computing devices, the one or more incorrect ads.

3. The method of claim 1, wherein the identifying the one or more incorrect ads comprises:
receiving an indication of a user interaction with a first ad of the one or more ads being displayed at the user device;
determining information regarding intended content that should be displayed in response to user interaction with the first ad;
determining if the intended content is being displayed correctly based on the information regarding the intended content; and
identifying the ad as an incorrect ad if the intended content is not being displayed correctly.

4. The method of claim 3, wherein the information regarding intended content that should be displayed in response to user interaction with the first ad comprises one or more content items.

5. The method of claim 4, wherein determining if the intended content is being displayed correctly comprises determining if the one or more content items are being provided for display at the user device.

6. The method of claim 3, wherein the information regarding intended content that should be displayed in response to user interaction with the first ad comprises one or more display information regarding the intended content.

7. The method of claim 6, wherein determining if the intended content is being displayed correctly comprises determining if the intended content is provided for display at the user device according to the display information.

8. The method of claim 1, the method further comprising receiving the information regarding the one or more ads along with the one or more ads.

9. The method of claim 1, wherein the information regarding the one or more ads includes a total number of the one or more ads.

10. The method of claim 9, wherein determining if the one or more ads are displayed correctly comprises determining if a number of ads equal to the total number are being provided for display at the user device.

11. The method of claim 1, wherein the information regarding the one or more ads includes an identifier of each of the one or more ads.

12. The method of claim 11, wherein determining if the one or more ads are displayed correctly comprises determining if ads having the same identifier as the one or more ads are being provided for display at the user device.

13. The method of claim 1, wherein the information regarding the one or more ads includes a location associated with each of the one or more ads.

14. The method of claim 13, wherein determining if the one or more ads are displayed correctly comprises determining if each ad of the one or more ads is being provided for display at or near the location associated with the ad.

15. The method of claim 1, the method further comprising:
adjusting metrics regarding the one or more incorrect ads based at least in part on the fact that the identified one or more incorrect ads have been displayed incorrectly.

16. A system for detecting an error in displaying advertisement content, the system comprising:
one or more processors; and
a machine-readable medium comprising instructions stored therein, which when executed by the processors, cause the processors to perform operations comprising:
receiving content including one or more ads for display at a user device;
receiving information regarding the one or more ads at the user device, the information including one or more of a total number of ads, an identifier of each of the one or more ads and a location associated with each of the one or more ads;
generating a user interface for display based on the received content;
determining if at least one of the one or more ads is not displayed correctly within the user interface based on the information regarding the one or more ads; and
identifying an incorrect ad of the one or more ads not being displayed correctly within the user interface if at least one of the one or more ads is not displayed correctly within the user interface;
updating advertiser information regarding the incorrect ad, wherein the advertiser information regarding the at least one of the one or more ads includes one or more of a price charged for the incorrect ad or metrics regarding the incorrect ad.

17. The system of claim 16, the operations further comprising:
receiving an indication of a user interaction with a first ad of the one or more ads being provided for display within the user interface;
determining information regarding intended content that should be displayed in response to user interaction with the first ad;
determining if the intended content is being provided for display at the user device correctly based on the information regarding the intended content; and
updating advertiser information regarding the first ad, if the intended content is not being displayed correctly.

18. The system of claim 16, wherein the determining if at least one of the one or more ads is not displayed correctly within the user interface comprises:
determining a number of ads displayed within the user interface;
determining if the number of ads displayed within the user interface is equal to the total number of ads;
determining that at least one of the one or more ads is not displayed correctly if the number of ads displayed within the user interface is not equal to the total number of ads;
identifying at least one of the one or more ads not displayed within the user interface as the incorrect ad in response to determining that the number of ads displayed within the user interface is not equal to the total number of ads.

19. A machine-readable medium comprising instructions stored therein, which when executed by a machine, cause the machine to perform operations comprising:
receiving one or more ads for display at a user device in response to a request from a user at the user device;
determining information regarding the one or more ads;
determining that at least one of the one or more ads are not displayed correctly based on the information regarding the one or more ads, the at least one of the one or more ads that are not displayed correctly comprising one or more incorrect ads, wherein the one or more incorrect ads are not displayed correctly due to an ad blocker application present as part of a web browser of the user device;
identifying the one or more incorrect ads; and
updating advertiser information regarding the incorrect ad based at least in part on the fact that the identified incorrect ad has been displayed incorrectly.

20. The machine-readable medium of claim 19, wherein the information regarding the one or more ads includes one or more of a total number of ads, an identifier of each of the one or more ads and a location associated with each of the one or more ads, and wherein the advertiser information regarding the incorrect ad includes one or more of a price charged for the incorrect ad or metrics regarding the incorrect ad.
